(19) United States
(12) Patent Application Publication
(10) Pub. No.: US 2016/0031364 A1
(43) Pub. Date: Feb. 4, 2016

(54) U-TURN SIGNALING SYSTEM FOR MOTOR VEHICLES

(71) Applicant: JAMES HENRY KERR, SAN DIEGO, CA (US)

(72) Inventor: JAMES HENRY KERR, SAN DIEGO, CA (US)

(21) Appl. No.: 14/530,665

(22) Filed: Oct. 31, 2014

Related U.S. Application Data
(60) Provisional application No. 61/894,631, filed on Oct. 23, 2013.

(51) Int. Cl. B60Q 1/34

(52) U.S. Cl. CPC B60Q 1/34

(57) ABSTRACT

This inventive idea proposes a U-turn signaling system for motor vehicles using a grouped series of 2 or 3 rapid turn indicator flashes followed by an interval and repeated in a continuous manner, distinct from the regularly repeating single flash of current left or right turn signal indicators, to alert other vehicles and pedestrians of a vehicle's impending U-turn thus allowing for a safer and more unimpeded flow of traffic through intersections and on streets and roadways for all police, civilian, and emergency vehicles.

### RELATED APPLICATIONS

Provisional patent application No. US61/894,631

### FEDERALLY SPONSORED DEVELOPMENT

Not Applicable

### BACKGROUND OF THE INVENTION

Currently, motor vehicles are required to be equipped with externally mounted turn indicators to signal when the vehicle is preparing to make a significant change in direction (i.e. lane change, left or right turn). This serves as a warning to other vehicles, cyclists, and pedestrians of the signaling vehicles intended change in direction so that they may take appropriate action to avoid a possible collision. However, if a vehicle is making al U-turn there is no way to alert others of anything more than just a left or right turn. This becomes important with the execution of a U-turn in that it requires additional vehicle slowing during the U-turn and potential movement into an area of intended travel by other vehicles, cyclists, or pedestrians that are not anticipating the 180 degree turn instead of one of a lesser degree. For example, in FIG. 1 if vehicle A is making a left or right turn then other vehicles (B, C, or D)) or pedestrians (E) can anticipate a safe path of travel through the intersection. However, if vehicle A is making a left U-turn, current turn signals cannot indicate this to others traversing that intersection. Instead vehicle A could be U-turning abruptly and without warning directly into the intended paths of B, C, D, or E and possibly resulting in severe injury or damages to any of those crossing the intersection. A U-turn indicator signaling system could greatly improve the safe execution of any vehicle making a legal U-turn at an intersection or at any place on the street or roadway, even under illegal circumstances. With the prior warning of an impending U-turn by any vehicle, all others (vehicles, cyclists, and pedestrians) could adjust their speed and direction to effect safer travel through the area involved.

It would seem prudent that a unique signaling system be available on vehicles that could indicate when a vehicle is preparing to execute a U-turn and thus better warn others in order to increase the safe movement of all that might be affected by the vehicle making the U-turn.

With the ever increasing volume and flow of traffic on our streets and highways, it is all the more important to use every means possible to reduce crashes and injuries from vehicles making U-turns. There are many examples of accidents occurring during legal or illegal U-turns made by law enforcement personnel and civilians (Google; Accidents and U-turns).

### BRIEF SUMMARY OF THE INVENTION

The general idea of this invention is to improve the safety of vehicles making a U-turn, legal or illegal, by implementing a unique turn signal system that indicates a pending U-turn by the motor vehicle.

### BRIEF DESCRIPTION OF THE VIEWS OF THE DRAWINGS

FIG. 1 shows the potential travel of vehicles, cyclists (A, B, C, or D) or pedestrians (E) through a typical intersection when a vehicle (A) is making a U-turn through that intersection.

FIG. 2 demonstrates a proposed modification of a standard Turn Signal Module to add two additional detent positions for right (R U-T) or left (L U-T) U-turn signaling.

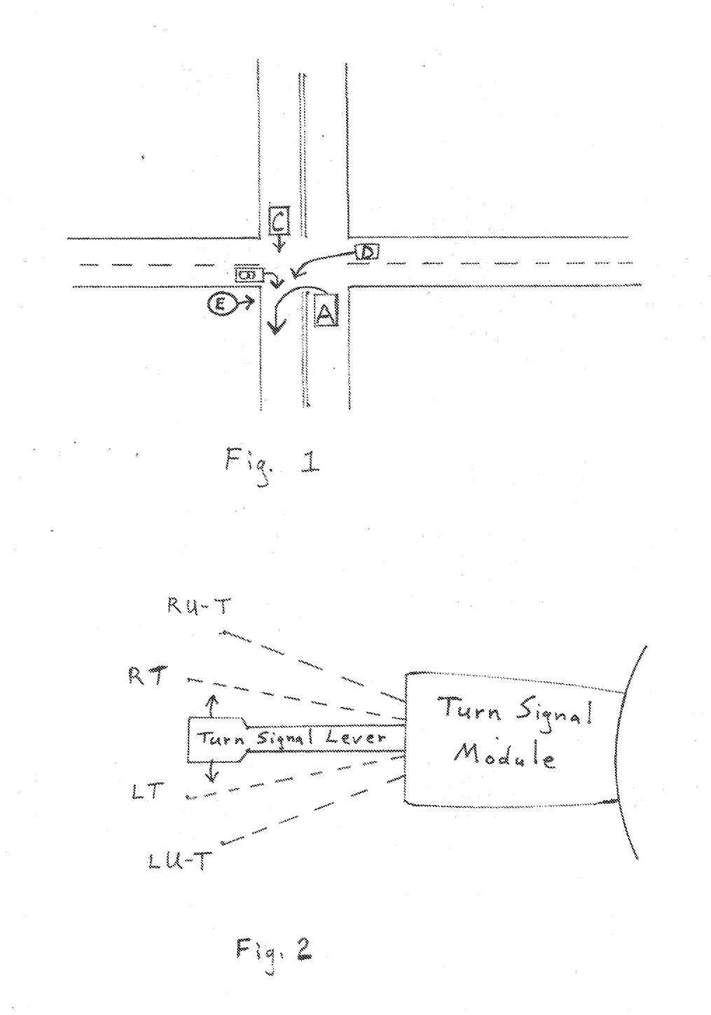

### DETAILED DESCRIPTION OF THE INVENTION

A standard U-turn signal module could be modified to generate a unique series of flashes to indicate a U-turn signal using the current external turn signal lights. One of the simplest solutions would be the repeating generation of two or three rapid flashes followed by a longer interval to make the signal distinctly different from that of the standard turn signal with its repeating flashes at the same regular, unchanging interval. Even in some vehicles with rapidly repeating turn signal flashes, the U-turn signal with two or three rapid sequential flashes followed by a longer interval would make it distinct from that of a regular left or right turn signal.

The generation of the double flash indicator could be produced by a proposed modification of the standard Turn Signal Module (FIG. 2) by adding two additional detent positions (FIG. 2: R U-T and L U-T) for right or left U-turns above and below the present right and left turn detents (FIG. 2: RT and LT). It would also require the modification of the Turn Signal Module to generate the double/triple flash U-turn signal from the upper or lower most detent positions in the module. The current wiring circuits would then carry the electric impulses to the external signal lights in the U-turn sequence generated by the turn signal module.

A U-turn indicator system with different colored external lights (ie. blue, red, green) for U-turn signaling, although possible, might be more confusing from lack of standardization in the automotive industry worldwide. In addition, such a system would require additional hardware, wiring, and light sources from that which is already in place in current automobile manufacturing. Also, changing current auto production to include such a U-turn signal system or retrofitting vehicles without the proposed double/triple flashing system would be more difficult and costly if using a multicolored signal light system.

1. Implementation of a simple, universally accepted U-turn signaling system for motor vehicles could potentially improve traffic flow and safety on our streets and roadways and reduce injuries of drivers and pedestrians as well as decrease property damage to property and vehicles of all types.
